(19) United States
(12) Patent Application Publication
(10) Pub. No.: US 2024/0320717 A1
(43) Pub. Date: Sep. 26, 2024

(54) AGGREGATION METHOD AND AGGREGATOR SYSTEM

(71) Applicant: STARCART OY, Helsinki (FI)

(72) Inventors: Pasi ILOLA, Helsinki (FI); Lauri PIISPANEN, Helsinki (FI)

(21) Appl. No.: 18/574,366

(22) PCT Filed: Jun. 17, 2022
(86) PCT No.: PCT/FI2022/050425

§ 371 Date: Dec. 27, 2023

(30) Foreign Application Priority Data
Jun. 30, 2021 (GB) 2109430.5
Nov. 18, 2021 (FI) 20216185

(51) Int. Cl. G06Q 30/0283; G06Q 30/0207

(52) U.S. Cl. CPC G06Q 30/0283; G06Q 30/0222

(57) ABSTRACT

A method, a system and a computer program product for providing a merchandise aggregation service that aggregates product catalogues of multiple third-party merchant systems into a single aggregated service. Contents of product catalogues of each third-party merchant system are obtained, and product details are consolidated into product data. A user selects multiple among the product data and adds these into a cart. Availability, price and delivery information for each product in the cart is updated by communicating with third-party merchant systems whose product catalogue contains the respective selected product. A combination of third-party merchants is determined that enables obtaining selected products for the lowest price and/or with the fastest delivery speed and presented to the user as one or more price offers. Purchase transactions are carried out for the selected products with the selected third-party merchants according to a purchase instruction received from the user.

### TECHNICAL FIELD

The invention relates to the field of internet shopping, a.k.a. web shopping, in particular to a method and system for facilitating communication between multiple independent merchant systems and a user device.

### BACKGROUND

An internet shopping purchase typically involves a user communicating with a single merchant directly via the merchant's web store in order to purchase a product, using a user device. Comparison services may draw product suggestions from multiple merchants, but ultimately direct the user to a single merchant's web store to carry out a purchase. Within a merchant's web store, a third-party payment system is typically used to handle card or other electronic money transactions. Marketplaces exist where multiple merchants may manually list their products, which are presented to and purchased from the marketplace.

### SUMMARY

An object is to provide a method and apparatus so as to solve the problem of aggregating purchases from a plurality of internet merchant systems. The objects of the present invention are achieved with a method according to the claim 1. The objects of the present invention are further achieved with an apparatus according to the claim 12 and with a computer program product according to claim 13.

The preferred embodiments of the invention are disclosed in the dependent claims.

According to a first method aspect, a computer-implemented method performed by a merchandise aggregation service is provided. The method comprises communicating with a plurality of third-party merchant systems to obtain contents of a product catalogue of each third-party merchant system, each product catalogue including product details, product prices and product delivery details for a plurality of products and consolidating obtained product details into product data. The method comprises receiving a plurality of product queries from a user device and providing to the user device, in response to each respective product query, product data, product prices and product delivery details for a subset of products matching the product query, and receiving a plurality of add-to-cart instructions from the user device, each add-to-cart instruction comprising identifying one or more selected products. The method also comprises communicating with one or more of the plurality of third-party merchant systems to obtain availability, price and/or delivery information for each selected product from each of the plurality third-party merchant systems whose product catalogue contains the respective selected product and determining a combination of third-party merchants from which the selected products can be obtained for the lowest price and/or a combination of third-party merchants from which the selected products can be obtained with the fastest delivery speed. The method further comprises providing one or more price offers to the user device, the price offers comprising the lowest price and/or the fastest delivery speed for the selected products and receiving a purchase instruction from the user device, the purchase instruction indicating a selected price offer among the one or more price offers. The method also comprises carrying out purchase transactions for the selected products from the third-party merchants comprised in the determined combination of third-party merchants based on the purchase instruction, wherein the purchase transactions are carried out by the merchandise aggregation service on behalf of a user of the user device.

According to a second method aspect, said consolidating obtained product details comprises categorizing products based on product details in the contents of the product catalogue obtained from each third-party merchant system after obtaining the contents of the product catalogue from the respective third-party merchant system, performing product matching by mutually associating the same products comprised in contents of obtained product catalogues of more than one third-party merchant system, wherein said product matching utilizes said categorizing of the products, and storing the categorized and matched products as a product data in a product database.

According to a third method aspect, the method further comprises consolidating product details of the matching products in the respective contents of the product catalogues of said third-party merchant systems into said product data.

According to a fourth method aspect, obtained contents of the product catalogue of each third-party merchant system comprises one or more offers, and the method further comprises categorizing a new offer after obtaining contents of the product catalogue from the respective third-party merchant system, wherein the offer comprises product details, product price and product delivery details, performing offer matching for mutually associating the new offer with an existing product in the product data that are in the same category, and adding or linking the new offer with product data of the matching existing product. Alternatively, if it is determined, in the step of performing offer matching, that there is no existing product in the product data that matches the new offer, the method comprises generating new product data based on product details comprised in the categorized new offer, and adding or linking the new offer with said new product data.

According to a fifth method aspect, product data is stored as product records, and wherein each product record comprises product details such as product name, product category or categories, product attributes, product specifications, product reviews, and wherein each product record comprises or is linked to at least one offer comprising third-party merchant information comprising product stock data, delivery time, delivery terms and cost data, and product price of the respective third-party merchant, and wherein offers are provided for each third-party merchant providing the same product.

According to a sixth method aspect, the subset of products is selected from the product database.

According to a seventh method aspect, the method comprises obtaining said product data, product prices and product delivery details for the subset of products matching the product query to the user device from the product database.

According to an eighth method aspect, said communicating with one or more of the plurality of third-party merchant systems to obtain availability, price and/or delivery information further comprises requesting discounted product prices from the third-party merchant systems and obtaining discounted product prices from the third-party merchant systems.

According to a ninth method aspect, carrying out the purchase transaction comprises obtaining a preauthorization for a payment transaction by the user, wherein total sum of the payment corresponds to combined price of all products included in said purchase instruction, and obtaining at least one virtual temporary credit, debit or credit/debit card, wherein the debit or credit limit of the at least one virtual temporary credit, debit or credit/debit card equals to said total sum of the payment transaction, and carrying out a purchase transaction by the merchandise aggregation service with each third-party merchant comprised in the determined combination of third-party merchants using one of the at least one virtual temporary credit, debit or credit/debit cards.

According to an alternative of the ninth method aspect, the method comprises obtaining at least one a virtual temporary credit, debit or credit/debit card, wherein the debit or credit limit of the at least one virtual temporary credit, debit or credit/debit card equals to a portion of said total sum of the payment transaction, and carrying out a purchase transaction with each third-party merchant comprised in a subset of the determined combination of third-party merchants using one of the at least one the virtual temporary credit, debit or credit/debit cards, and carrying out a purchase transaction by the merchandise aggregation system with remaining one or more third-party merchants comprised in the determined combination of third-party merchants but not included in the subset of the determined combination of third-party merchants using an alternative payment transaction method, such as a SEPA payment.

In a further alternative of the ninth method aspect, the method comprises carrying out purchase transactions by the merchandise aggregation service with each of the third-party merchants in the determined combination of third-party merchants using an alternative payment transaction method, such as a SEPA payment, and confirming settling the purchase transaction to the user device upon completing the purchase transactions with said third-party merchants comprised in the determined combination of third-party merchants.

According to a tenth method aspect, the method comprises, after providing one or more price offers to the user device, adding one or more of the selected products in one or more third-party merchant carts provided by the respective one or more third-party merchant systems based on the provided one or more price offers to the user device.

According to an eleventh method aspect, the one or more selected products are added in said one or more third-party merchant carts before or after said receiving a purchase instruction from the user device.

According to another aspect, a computer device or system is provided that comprises at least one processor configured to perform the method of any of the above method aspects.

According to a further aspect, a computer program is provided, comprising instructions which, when the program is executed by a computer device or system, cause the computer device or system to carry out the method of any of the above method aspects.

According to a yet further aspect, a computer-readable medium is provided, the computer-readable medium comprising instructions which, when executed by a computer device or system, cause the computer device or system to carry out the method of any of the above method aspects.

The present invention is based on the idea of combining features of a comparison service and a marketplace into a merchandise aggregation service. Product information from a plurality of different merchants' web stores, here referred to as third-party merchant systems or in short merchant systems, is aggregated and made available for comparison. Both price and delivery speed can be optimized according to the user's preferences. The client performs a single payment transaction with the merchandise aggregation service, and the merchandise aggregation service performs the purchase or purchases from the web shop on behalf of the client.

The present invention has the advantage that it enables a client, also referred to as a user to perform the entire process of internet shopping from a plurality of merchant systems via a single point of contact.

### BRIEF DESCRIPTION OF THE DRAWINGS

In the following the invention will be described in greater detail, in connection with preferred embodiments, with reference to the attached drawings, in which

FIG. 1 shows a high-level schematic of main parties involved in the method.

FIG. 2 illustrates modules of the merchandise aggregation service.

FIG. 3 illustrates method steps performed before purchase of products.

FIG. 4 illustrates method steps for adding offers and/or products in the aggregated product catalogue.

FIGS. 5a and 5b illustrate a product view in a user interface.

FIG. 6 illustrates a product view in the user interface.

FIG. 7 illustrates a cart view of the aggregated shopping cart in the user interface.

FIG. 8 illustrates steps of a method of performing a purchase according to a first embodiment.

FIG. 9 illustrates steps of a method of performing a purchase according to a second embodiment.

### DETAILED DESCRIPTION

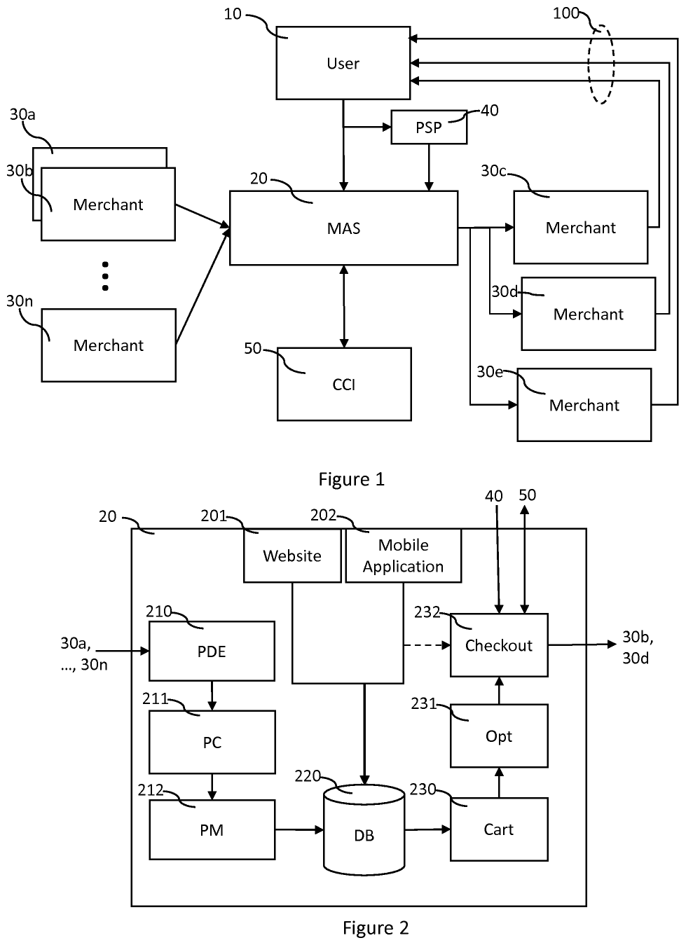

The FIG. 1 shows a high-level schematic of parties involved in the method. A consumer, here referred to as a user (10) interacts with the merchandise aggregation service (MAS) (20) using a user device, such as a computer device or a mobile communication device. The MAS (20) extracts contents of product catalogues of a plurality of merchants from a plurality of merchant systems (30a, 30b, . . . , 30n) and consolidates this into a single, coherent collection of product data that is stored in the MAS (20). The product data appears to the user (10) as a single, coherent product catalogue. In this context, merchants refer to third-party merchants, who have their own merchant systems that are operationally independent from the MAS (20). Upon accepting the purchase, a purchase instruction is given to the MAS (20) and the user (10) completes a primary checkout process with the MAS (20) using his/her user device. From the MAS (20) point of view, the primary checkout may also be referred to as a client-facing or user-facing checkout. The MAS (20) first receives a payment preauthorization for the purchase from a payment service provider (PSP) (40). Preferably, upon receiving the payment preauthorization, the MAS (20) creates a purchase order in each respective merchant system (30c, 30d, 30e) via its respective merchant system's shopping cart and checkout functionality. A checkout with the third-party merchant is referred to as a merchant-facing checkout, or in short, a merchant checkout. The process of performing all merchant checkouts required for completing purchase of the items included in the primary checkout is referred to as a secondary checkout. In the secondary checkout, a merchant checkout is performed in each respective merchant system utilizing merchant checkout service provided by the respective merchant system, paying for the purchases to these merchants using virtual credit, debit or credit/debit cards provided by a credit card issuer (CCI) (50). The purchase order is finalized with the respective merchant checkout at each merchant system in the name of the user (10) and paid by the MAS (20) in the name of the user (10). Thus, the purchase in each third-party merchant system appears as if it was performed by the user (10). Each merchant delivers (100) orders to the user (10) using their own delivery channels just as if the user (10) made the purchase via the merchant's own merchant system.

Communication between different parties is performed over a data communication network, such as the Internet.

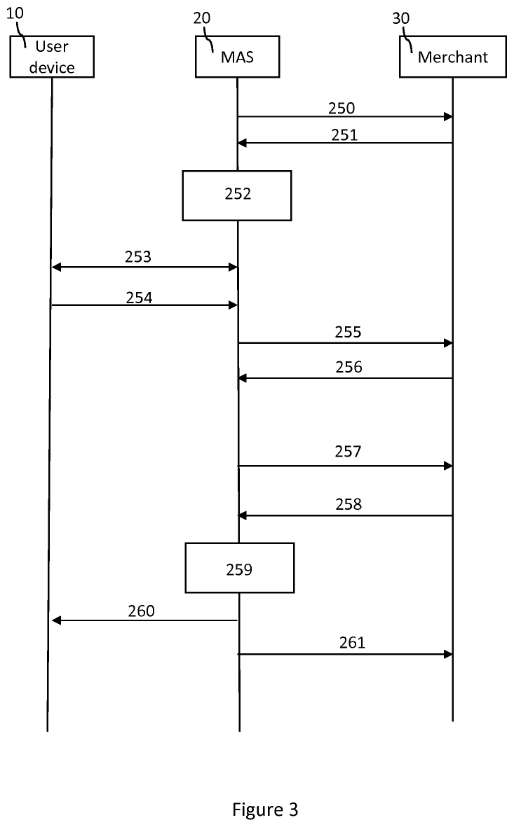

The FIG. 2 illustrates main functionalities of the merchandise aggregation service (20) implemented as software operating in a computer or in a computer system. For example, the computer may be a physical and/or virtual server, or the computer system may be an array of physical and/or virtual servers, or it may be a cloud computing system. Functionalities of the MAS (20) are preferably implemented as software modules, which may comprise one or more submodules.

Product data is initially extracted from the obtained contents of product catalogues of the third-party merchants by a product data extraction module (PDE) (210). Many merchants use platforms, such as Shopify™, for implementing their merchant systems. Such platforms may be provided with specific integrations, APIs, plugins and/or automations, which expedite extracting product details from these platforms. Even if number of platforms used by different merchants is limited, product details in different merchant systems (30a, . . . , 30n) are typically not uniform. Products may be named differently, and different product categorizations may be used. For being able to provide a single, combined selection of products to the user, product details obtained from third-party merchants' merchant systems are preferably consolidated into a single, coherent collection of product data.

Consolidation of product details in obtained contents of product catalogues of third-party merchant systems is achieved in the MAS (20) by categorizing and matching obtained products and product details. Each obtained product catalogue comprises a plurality of products, each represented by data associated with a particular product. First, products are categorized by a product categorization module (PC) (211). Product categorization process unifies categorization of products by utilizing product details thereof to apply a categorization defined in the MAS (20) and improves effectiveness of the subsequent product matching step by filtering out large numbers of known negative matches (mismatches). The PC (211) preferably utilizes machine learning and/or artificial intelligence to continuously improve its algorithms for product categorization. Various pieces of data included in the obtained contents of product catalogues is used by the product categorization process, such as category information as listed by the third-party merchant, but also, the Global Trade Item Number (GTIN), Manufacturer Part Number (MPN), manufacturer brand name and/or any product specifications, descriptions and/or product titles, if available.

After product categorization, a product matching step is performed by a product matching module (PM) (212), which determines which products extracted from different merchant systems' product catalogues are representations of the same product. The PM (212) utilizes machine learning and/or artificial intelligence for product matching. This way the PM (212) can constantly improve its algorithms used for product matching. In this context, product data refers to a consolidated collection of product details after the obtained products, represented by contents of the obtained product catalogues, have been categorized and products have been matched in the MAS (20).

Product data is stored in a product database (DB) (220) preferably as product records, each product record comprising product data of one product. Product data in the product database comprises at least product names and product attributes and may comprise further information such as product ratings and/or product reviews, both of which may be consolidated from product ratings and/or reviews obtained as part of product details obtained from merchant systems. A product name is selected or generated for each product on basis of product names of the product used in the third-party merchant systems. Likewise, a product description is selected or generated for each product on basis of product descriptions provided for the product in the third-party merchant systems. Preferably, each product, represented by respective product data in the product database is directly associated with at least one product category in the DB (220). Any applicable product categorization may be used in the MAS (20). Product records in the DB (220) preferably comprise or are associated (i.e. linked) with information concerning respective merchants and/or merchant systems from which the product is available as well as price information of the product at each respective merchant and product delivery details as provided by the respective merchant system.

According to a preferred embodiment, two types of records are used by the MAS (20): product records and offer records. According to some embodiments, product and offer records are arranged and named according to so called schemas defined by Schema.org™, which is a collaborative, community activity that facilitates creation, maintaining and promoting schemas for structured data on the Internet and web pages. Both types of records may be stored in the DB (220) or they may be stored in at least two different but operationally coupled databases. Each product record comprises product data, i.e. all relevant information directly concerning the product itself. Each offer record comprises one offer obtained from a merchant's system, comprising at least an identifier of the product and information on product price, availability and/or delivery details. According to some embodiments, a Global Trade Item Number (GTIN) may be used as an identifier of a product both in the product data and/or product record and in the offer record. The GTIN, or any other applicable unique identifier of the product, enables mutually linking products and respective offers.

The user interface towards the MAS (20) is preferably provided by at least one of an internet site (201), also referred to as a website, and a mobile application (202). The user interface comprises features that enable the user to access and browse product data stored in the DB (220), to add products into an aggregated shopping cart, to optimize their purchase and to pay for the purchase as will be described below. The user interface preferably appears to the user (10) as a single, aggregated product catalogue that comprises all products included in the DB (220) and all offers, whether stored in the same DB (220) or in another database operatively associated with the DB (220). When product records and offer records are applied, these form the basis for displaying products and prices thereof as well as generating the aggregated shopping cart.

During browsing the MAS product catalogue comprising products and offers linked therewith, the user is provided with initial price information. For example, the lowest price of the product by any one of the merchants who has this product in their product catalogue may be displayed as a default price during browsing of products. Alternatively, prices of the same product from several merchants may be displayed during browsing, and/or prices of the same product from several merchants may be provided as additional information that is displayed in additional product information on the respective product's web page, also referred to as a product view in the MAS (20) user interface, or such additional information may be displayed in the user interface per user's request.

While browsing the products available in the MAS (20) that are represented by product data stored in a product database of the MAS (20), the user selects products by adding the product into an aggregated shopping cart provided by the MAS (20). The aggregated shopping cart, which may be shortly referred to as a cart, is implemented with a cart module (230). As known in the art, the concept of cart in an internet shop (web shop) refers to a virtual shopping cart in which products selected by the user for purchase are collected before the user proceeds to a to perform the purchase, i.e. placing a purchase order and paying for the ordered products. Products may also be removed from the cart by the user.

Before the primary checkout, the aggregated shopping cart is optimized by a cart optimization module (Opt) (231). Cart optimization comprises selecting at least one recommended provider for each of the product(s) to be purchased among a plurality of merchants that can provide the same product. Cart optimization may be performed at least based on price and/or delivery speed. In some embodiments, cart optimization takes into account available discounts on delivery based on total of purchase prices. For example, if a merchant offers free delivery for purchases exceeding a given total purchase price threshold of the merchant, the optimized aggregated shopping cart may indicate to the user that by purchasing certain items from one merchant, the total price is lowest because no delivery cost is added, in comparison to selecting individually lowest product prices from different merchants but paying extra for delivery of the items because the total price would not exceed a free delivery price threshold of one or more of these merchants. Cart optimization preferably takes into account any terms associated with pricing and/or delivery, such as the delivery cost and/or time depending on location of the user and delivery service provider. Typically, merchants use third-party delivery service providers to deliver items to the customers, and each merchant may use services by several alternative delivery service providers, each having their own delivery times and prices.

According to some embodiments, the Opt (231) module communicates with one or more of the plurality of merchant systems to obtain up-to-date availability, price and/or delivery information. For example, communication is initiated when the user opens the aggregated shopping cart for reviewing contents thereof. This step enables the Opt (231) module to request discounted prices from any merchant systems and obtaining discounted product prices from the merchant systems for determining the best combination for performing purchases of selected products included in the cart: which products should be purchased from which merchant for minimizing the total price and/or the delivery time.

The cart optimization step may comprise a step of calculating at least one discount. For example, each merchant may define a maximum discount allowed for the MAS (20) to offer in comparison to the normal list price of the product at a respective merchant's merchant system. The discount enables merchants to bid against each other for winning the sale. The maximum discount may be defined for example as a percentage. For example, a merchant may offer a discount for individual products, for product categories, for any purchase exceeding a predefined price threshold or for the entire product selection. However, the MAS (20) does not necessarily use the maximum discount; if a fraction of the maximum discount is sufficient for reducing the price below respective offers by other merchants, only the fraction of the maximum discount is offered to the user.

As a result of the cart optimization, it is determined from which merchant each individual product in the aggregated shopping cart is to be purchased to achieve the best price for the total purchase, covering all products included in the aggregated shopping cart and/or to achieve the fastest delivery speed for all products included in the aggregated shopping cart. The optimized aggregated shopping cart is a result of considering all of the purchase prices of the products, possible discounts thereof, and delivery options. Delivery options comprise for example delivery price, delivery speed and/or delivery service providers. The cart optimization module (231) may comprise an intelligent discount service submodule, which performs the above-mentioned steps of requesting prices, stock and delivery information and any available special discounts, from all merchants who have the respective product(s) in their product portfolio that are included in the user's aggregated shopping cart. According to some embodiments, more than two alternatives may be provided for the optimized aggregated shopping cart. For example, one alternative may provide the best price while another alternative may provide the fastest delivery speed. According to some embodiments, the user may select whether the cart optimization module optimizes the cart based on price and/or delivery speed.

For facilitating a successful purchase from any of the merchants having the product in its selection, the products included in the aggregated shopping cart are initially inserted to a shopping cart of each respective merchant system, referred herein as a merchant cart, by the MAS (20). Any products placed in merchant carts that are not selected in the optimization and/or in the purchase instruction by the user may be later removed. Removal of products from non-selected merchant carts may be performed upon entering the primary checkout step or later during or after the primary checkout step.

After finishing cart optimization and receiving a purchase instruction from the user, the MAS (20) proceeds with the primary checkout. During the primary checkout, the user commits to a single payment for all purchases included in the optimized, aggregated shopping cart, including the price of the products and applicable delivery costs. This single payment transaction by the user is performed in the conventional manner via the PSP (40) using preferably Strong Customer Authorization (SCA) as defined in Payment Services Directive (PSD2) regulation in Europe. A payment according to this standard comprises steps of a preauthorization and transaction settling. After successful preauthorization by the PSP (40) the total sum is reserved (held) in the user's account or payment card, and this is confirmed to both the user and the MAS (20). Preferably upon receiving a confirmation of the payment preauthorization, the MAS (20) proceeds to a secondary checkout performed in control of the checkout module (232). The secondary checkout comprises steps that enable performing actual product purchases from the selected merchants.

According to some embodiments, the primary checkout is performed by a separate primary checkout module associated with the website (201) and/or the mobile application (202). According to some embodiments, the primary checkout is performed by or under control of the checkout module (232) that also controls the secondary checkout.

According to some embodiments, upon receiving a confirmation of successful payment preauthorization from the PSP (40), the checkout module first proceeds to acquiring at least one virtual temporary credit, debit or credit/debit card, also referred to as a virtual credit, debit or credit/debit card, provided by a third-party credit card issuer (CCI) (50). The virtual temporary credit, debit or credit/debit card preferably has a credit, debit or credit/debit limit that equals the total of the aggregated purchase of the user. Alternatively, more than one virtual temporary credit, debit or credit/debit card is acquired, each having a credit and/or debit limit that equals to the total of the respective purchase from one of the merchant systems, including price of the products and their delivery cost, if applicable. Acquiring a separate virtual temporary credit, debit or credit/debit card for each purchase from each third-party merchant adds security, since misusing the virtual temporary credit, debit or credit/debit card is even more difficult, if it is clearly obtained for performing a single payment transaction, and the respective credit or debit limit is fully consumed in this single payment transaction. A total price of a purchase from each merchant includes cost of respective products and any additional costs such as delivery costs. In response to successfully activating the virtual temporary credit, debit or credit/debit card, the CCI (50) provides card information to the MAS (20), comprising a Bank Identification Number (BIN), expiry date and a card verification code (cvc), also known as a card security code (csc), just as any normal credit, debit or credit/debit card. Using a virtual temporary credit, debit or credit/debit card improves security, because it can only be used to make the payment, but it will not work after the purchase. Further, the virtual temporary credit, debit or credit/debit card number cannot be traced back to any original card used by the user.

According to some embodiments, payments of the secondary checkout process may also be performed by other known secure, cashless payment means, such as single euro payment area (SEPA) payment. A SEPA payment may provide a more cost-efficient payment method both for the MAS (20) and the third-party merchant (30). Payment methods used in the secondary checkout process with third-party merchants may vary between different third-party merchants.

The purchase from each respective merchant selected by the user for delivering the product(s) is then performed by the checkout module of the MAS (20), preferably using Strong Customer Authentication (SCA), also known as EMV 3D Secure (“Eurocard, Master, Visa” 3D Secure), as defined in the PSD2 regulation in Europe. The check-out module (232) auto-approves SCA and validates actual payment information with the merchant system with what is in the respective merchant cart in the merchant system. After successfully finishing SCA, the actual payment is authorized and completed.

After the actual payment(s) to merchant system(s) has/have been completed, the user transaction is settled with the PSP (40) and the user interface of the MAS (20) confirms a successful purchase to the user as indication of the successfully completed secondary checkout process.

Delivery of the product is performed by the merchants (30c, 30d, 30e) according to the terms of the purchase(s) that was/were completed by the MAS (20) on behalf of the user.

Although FIGS. 1 and 2 show, for illustration purposes, merchants 30c, 30d, 30e separately from the list of merchants (30a, 30b, . . . 30n), it should be understood that also merchants 30c, 30d and 30e are comprised among merchants whose merchant systems are interacted with for the purpose of collecting product data into the aggregated product database based on contents of the respective product catalogues received form the merchant systems.

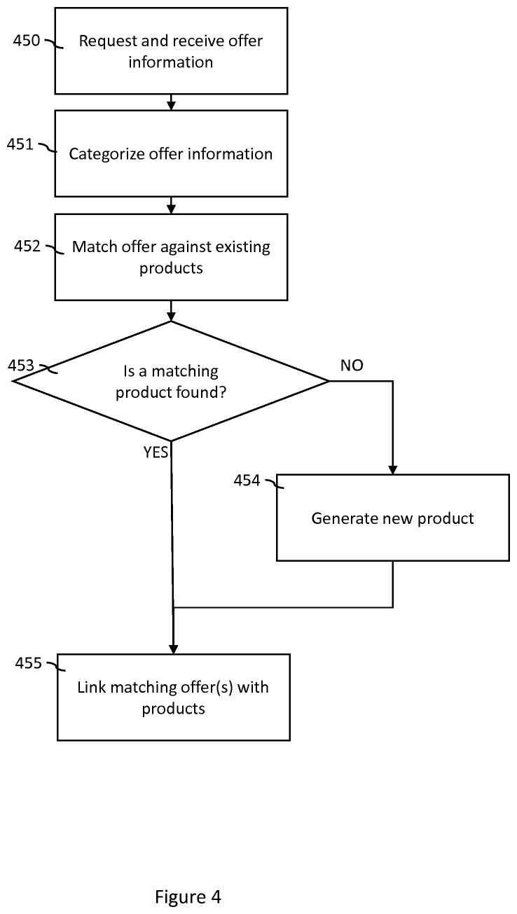

The FIG. 3 illustrates method steps performed before purchase of products according to embodiments of the invention as a high-level signaling diagram.

In step 250 the MAS (20) contacts the merchant system (30) for obtaining information concerning contents of product catalogues with prices, as well as delivery details, such as delivery methods and terms. In step 251 product details, prices and delivery details are provided from the merchant system (30) to the MAS (20). Product details, product prices and delivery details received from the merchant are then processed (252), preferably by PDE (210), PC (211) and PM (212) modules of the MAS (20). By performing steps 250, 251 and 252 for all available merchant systems (30), the respective modules of the MAS (20) enable generating an aggregated product catalogue for the user, the aggregated product catalogue comprising product information covering products of all respective merchants, as well as respective delivery method and term information for all merchants.

In step 253, the user browses the aggregated product catalogue using a provided user interface and selects one or more products from the aggregated product catalogue by adding (254) these products into the aggregated shopping cart provided by the MAS (20). In step 255, the MAS (20) contacts merchants that were determined to have respective product(s) available based on contents of the respective product catalogue of the merchant obtained from the merchant system. Price and availability are verified by each respective merchant systems (30). This information is initially provided for the user in the user interface's product page, which comprises a list of merchants from which the product can be purchased from. The product page may also list further information, such as an initial price offer, stock information, delivery information, delivery terms and/or an initial delivery price, all obtainable from the product database.

Steps 257 to 259 illustrate high level steps of an intelligent discount service provided by the MAS (20). In step 257, the MAS (20) requests up-to-date prices from each merchant having the respective product in their product portfolio, as indicated by contents of the obtained product catalogue. In step 258, contacted merchants respond by providing information on discounted prices, if available. Discounts may be offered by the merchant system for individual products or discounts may be offered for example for a category of products. According to some embodiments, the discount is defined by the merchant using a maximum discount percentage or sum. In step 259, the MAS (20) processes prices, discounts and delivery options of all merchants of all products included in the aggregated shopping cart to optimize price and/or delivery options.

The optimization module may use just part of a maximum discount offered by any one of the merchants for calculating the optimized price. By comparing prices, possible discounts and delivery details of different merchants, the final price offered for the user may have less discount than the maximum discount allowed by the merchant for this product or category of products. Preferably, the MAS (20) intelligently uses a minimum discount that provides the most competitive total price among all available price options for the product, including delivery. This principle can be explained with a simple, practical example: Merchant A sells a product for a list price of 100 EUR, but offers up to 10% discount for products in this category, while merchant B sells the same product for a list price of 95 EUR, but has no discount available. This price range has equal delivery costs and delivery time from both merchants. The MAS (20) may decide to offer the product to the user from merchant A for a price of 94 EUR, i.e. with a 6% discount, which is less than the maximum 10% discount, but provides the user with the lowest price.

As the result of the price and/or delivery option optimization, the MAS (20) updates (260) the contents of the aggregated shopping cart as needed and shows to the user optimized prices and/or delivery options for the products included in the aggregated shopping cart. In step 261, the MAS (20) inserts respective items into the merchant cart(s) of the selected merchant(s) system(s).

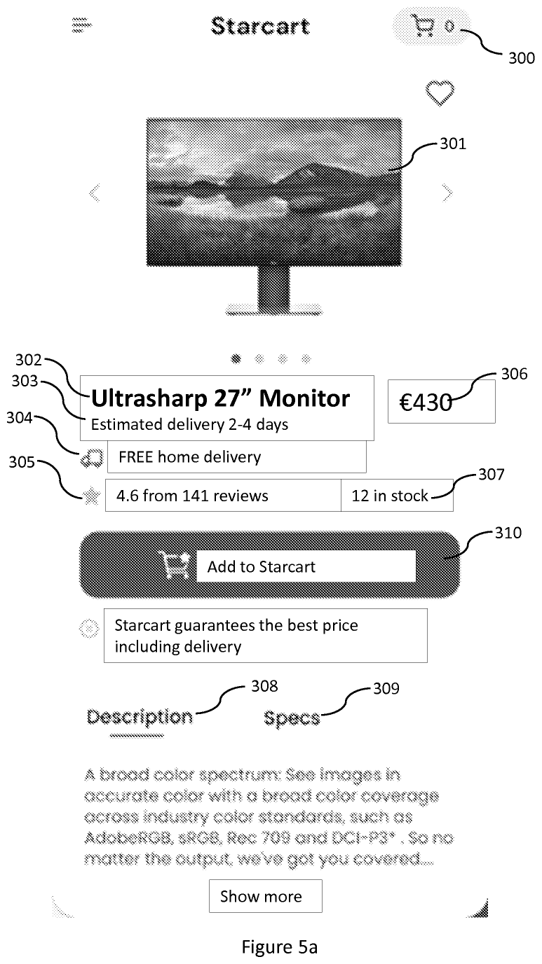

FIG. 4 shows steps for adding new offers and/or new products into the aggregated product catalogue of the MAS (20). In this example, offer information preferably refers to information provided by means of offer records.

In step 450, offer information is requested and received from a merchant. In step 451, offer information received from the merchant is categorized by associating offers to product categories used by the MAS (20). In step 452, each new offer received from the merchant is matched against existing products in the aggregated product catalogue. If it is determined in step 453 that a product exists in the aggregated product catalogue and that it can be matched with an offer received from the merchant system, the offer is linked to the product in step 455. If it is determined that no matching product exists in the aggregated product catalogue, a new product is generated in step 454, and the received offer is then linked with the new product. This way the aggregate product catalogue is automatically expanded to include new products whenever an offer for a new product not previously present in the MAS product catalogue is received from any one of the third-party merchant systems.

As a result, product data comprised in the product database and representing products is linked to matching offers, and initial prices, stock information and delivery details, all obtained based on the matched offers, can be represented to the user for example in the product catalogue, search results, product views and/or in the aggregated shopping cart.

Each product record in the MAS product database (220) may be linked to a plurality of offers. However, each offer obtained from a third-party merchant is only linked to a single product.

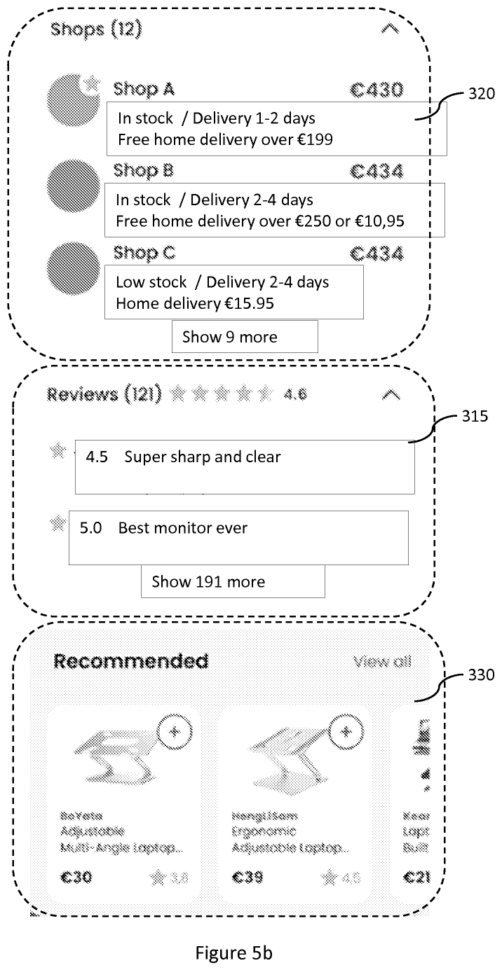

FIGS. 5a, 5b, 6 and 7 illustrate exemplary views in a user interface during different phases of the aggregated purchase process.

The FIG. 5a shows a portion of an exemplary product view, also referred to as a product page, in the user interface of the MAS (20) that provides product information on a particular product, a display monitor of a selected type. Product information shown in the product view is quite typical for a merchant system, comprising for example one or more images (301) of the product, name (302), price (306), estimated delivery speed (304), delivery terms or price (305), product review summary (305), stock information (307), description (308) of the product and technical specifications (309) of the product. As known in the art, selection of basic information shown in the product view is a design option. For example, in this example the description (308) and specification (309) are provided under user-selectable tabs. Further, like in a typical web store, the product view comprises a cart summary widget (300) showing the number of items currently added to the aggregated shopping cart and at least a cart adding button (310) for adding the currently displayed product in the aggregated shopping cart.

Product information shown on the product view comprises consolidated product data that combines product details obtained from several merchant systems. For example, product review (305) may be a compilation of all product reviews for the same product obtained from different merchants. A single representative price, delivery and stock information is preferably selected among the several merchants and shown in the user interface. Preferably, these represent the best available purchase terms available from any of the merchants, as selected by the MAS (20).

The FIG. 5b illustrates further information available in a product view. Based on merchant data associated with the respective product, an entire list of merchants (320), i.e. “shop A”, “shop B”, “shop C” is provided for each product, with information of respective price, stock, and delivery terms of each merchant. This list of merchants (320) is preferably arranged in increasing product price order, cheapest first. Product reviews (315), preferably comprising a compilation of product reviews for the respective product obtained from all listed merchants, are available for browsing in the product view.

Further recommended products (330) may also be shown in the product view. These recommended products are preferably selected using artificial intelligence.

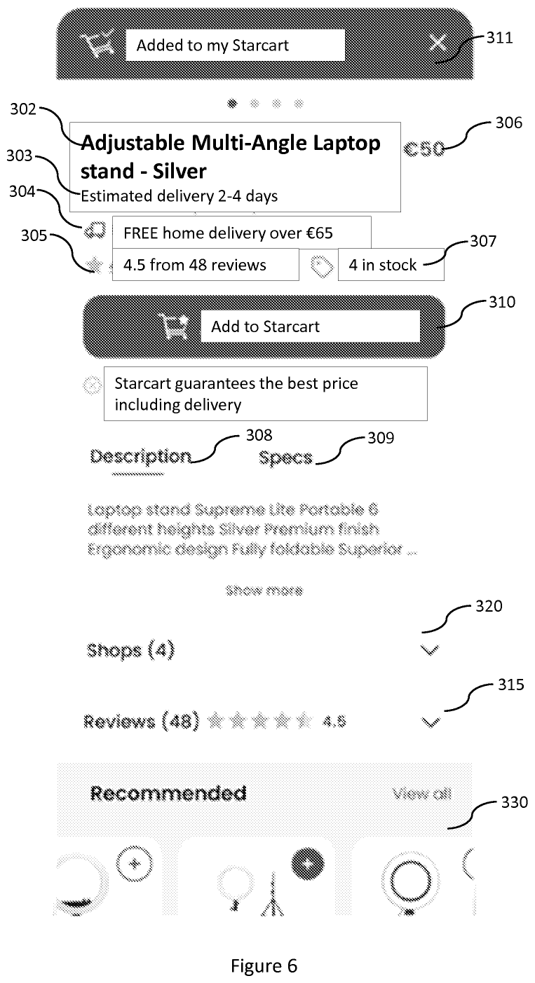

FIG. 6 illustrates another exemplary product view. The user has already added this product to his/her aggregated shopping cart, as shown in the top banner (311). The price (306) is shown in the product view, but delivery terms (304) are not optimized—the price (306) of the product does not reach the free home delivery minimum of the respective merchant. In this exemplary compact view, the list of merchants (320) and product reviews (315) are hidden from view, shown here as accordions, which make the details available for viewing by clicking.

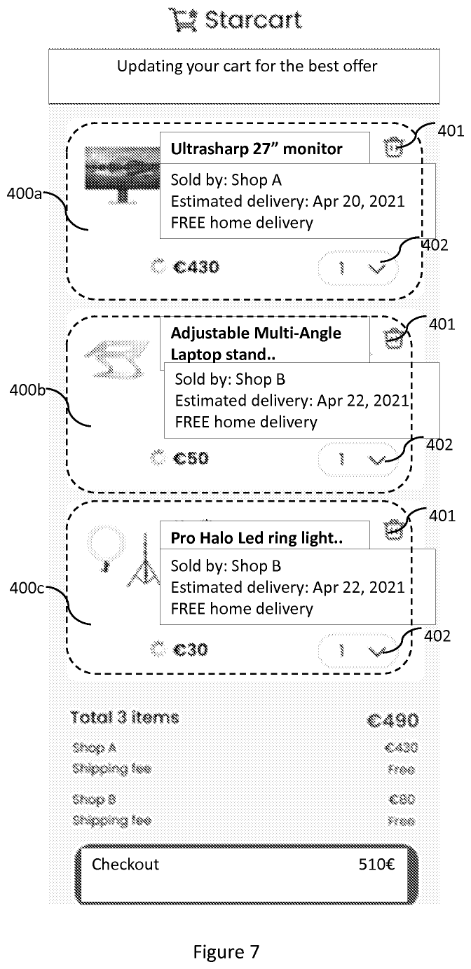

FIG. 7 shows an exemplary user interface showing contents of a cart view of the aggregated shopping cart as provided to the user. Preferably, upon entering the cart view, the cart optimization step of the aggregated shopping cart is performed by the cart optimization module. Alternatively, the cart can be optimized each time a new product is added in the aggregated shopping cart. In any case, the aggregated shopping cart should be optimized before performing the primary checkout.

Optimizing the cart each time a new product is added into it can be performed in the background during browsing of the aggregated product catalogue, and thereby reduces the communication and data processing steps required upon entering the primary checkout. Thus, the user experience may be improved by shortening the waiting time required for cart optimization and retrieval of the price offers indicating the lowest prices and/or the shortest delivery times. On the other hand, optimizing the aggregated shopping cart constantly, while contents of the aggregated shopping cart evolve, requires more data processing and communication resources from the MAS (20) and, in particular, from its optimization module. The user may enter the cart view for example by clicking a cart summary widget shown in any view of the user interface, such as a product view or a search view as known in the art.

In this example, the user has selected three different products for purchase, which are listed (400a, 400b, 400c) in the cart view. Items may be removed from the aggregated shopping cart by clicking the respective removal symbol (401), and the number of each item included in the aggregated shopping cart is adjustable (402). During the cart optimization step, the cart optimization module communicates with all merchant systems providing products included in the aggregated shopping cart to obtain up-to-date availability, price and/or delivery information. Merchant systems to be communicated with are selected based on merchant information associated with the respective products. For example, merchant information may be provided by offers linked with the product data. The optimization step also includes requesting any available discounted prices from the respective merchant systems and obtaining discounted product prices from the merchant systems. Upon having all prices, availability information and delivery terms gathered, the cart optimization provides a recommendation for the user that provides the best total price for all items in the aggregated shopping cart, including both price of the items and delivery thereof. Alternatively, or in addition, the cart optimization provides a recommendation for the user that provides the fastest delivery speed for all items in the aggregated shopping cart.

In this example, for achieving the lowest total price, the monitor is recommended to be purchased from Shop A, while the two other products are recommended to be purchased from Shop B. The combined price of these two products exceeds the free home delivery price limit of the Shop B, thus avoiding any delivery cost.

The user accepts the proposal by proceeding to the primary checkout, during which the user pays the total sum as a single payment to the MAS (20) using any known internet payment method, preferably via a PSP (40). If the user is a registered user of the MAS (20), his/her contact details are already known by the MAS (20). If the user has not previously registered, his/her contact information will be requested during the primary checkout process as known in the art. The MAS (20) stores the user's contact details at least temporarily for using the user's contact details for performing purchases at the respective merchant system.

Upon receiving a confirmation of successful payment, the MAS (20) proceeds to making respective purchases in the selected merchant systems using the stored contact details of the user and paying the purchases for the respective merchants using temporary virtual credit, debit or credit/debit card(s) or by other known online payment methods, such as SEPA payment.

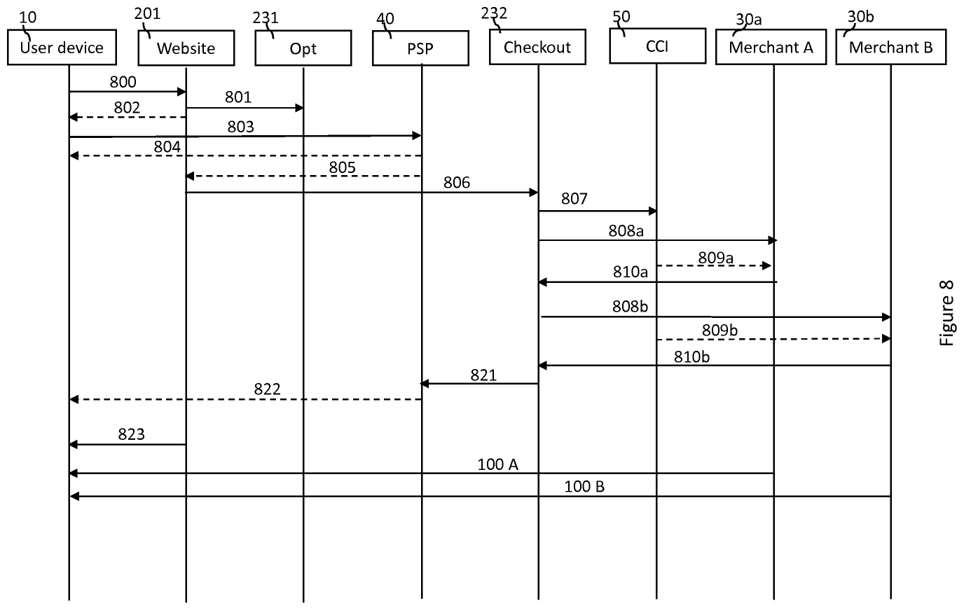

FIG. 8 illustrates schematically the main steps of a method of performing a purchase using the MAS website (201) according to a first embodiment. The basic steps of the method are the same also if the method was performed using a mobile application (202).

During step 800, the user adds items into the aggregated shopping cart using the website (201). Upon initiating the primary checkout by the user using his/her user device (10) for example by entering a cart view on the website (201) or by separately choosing an option to initiate optimization, the aggregated shopping cart is optimized (801) by the optimization module (231), choosing merchants and defining best available prices and/or fastest delivery speeds.

In step 802, an aggregated shopping cart checkout initiation view associated with the primary checkout, for example like what is illustrated in the FIG. 7, is provided for the user on the website (201), and the user enters to payment preauthorization (803) in communication with a PSP (40) as known in the art. The checkout associated with the aggregated shopping cart may be referred to as the primary checkout. For preauthorizing the payment, 3DS protocol or any alternatively available strong payment authorization method may be used. Preauthorization reserves the total sum required for payment for the contents of the aggregated shopping cart. Successful reservation of the sum is indicated to the user (step 804) and to the MAS (step 805).

Upon receiving (805) a confirmation of preauthorization for the payment from the PSP (40), the method proceeds to receiving a purchase instruction (806) from the user (10) via the website (201). The purchase instruction (806) initiates a secondary checkout process. The secondary checkout process comprises placing respective merchant purchase orders (808a, 808b) and making payments (809a, 810a; 809b, 810b) for purchases with those merchants who were selected in the optimized, aggregated shopping cart. In this example exemplary selected merchants are merchant A (30a) and merchant B (30b). The secondary checkout process is performed under control of the checkout module (232).

When a virtual credit, debit or credit/debit card is used for payment, a credit card issuer (50) is contacted by the checkout module (232) for obtaining at least one temporary virtual credit, debit or credit/debit card. A single temporary virtual credit, debit or credit/debit card may be obtained with a debit or credit limit that equals the total price of the purchase or more than one virtual credit, debit or credit/debit cards may be obtained, each having a credit or debit limit that covers total price of purchase of one of the selected merchants. The checkout module (232) adds products (808a, 808b) into merchant carts of the respective merchant systems (30a, 30b) and a merchant checkout is performed with each of the merchants. During merchant checkouts, purchases are paid (809a, 809b) to the respective merchants (30a, 30b) using the obtained one or more virtual credit, debit or credit/debit cards. Any known, secure payment authorization method may be used for performing these payments. After the payments to the merchants (30a, 30b) are successfully performed, each merchant confirms a successful merchant checkout (810a and 810b) to the checkout module (232). In response to receiving confirmations of all successful merchant checkouts for performing purchases of all products comprised in the optimized aggregated shopping cart, the checkout module (232) confirms (821) the successful secondary checkout to the PSP (40). The PSP (40) then confirms settling (822) of the user's payment transaction to the user (10). During performing the secondary checkout, the checkout module preferably communicates its states towards the website. For example, states communicated towards the website may comprise “pending”, “successful” and “error”. During the secondary checkout process, the user interface shown to the user may display a textual and/or graphical “processing” indicator as known in the art. Successful primary checkout is preferably confirmed to the user (10) via the user interface provided by the website in the step 823 only after all merchant checkouts have been successfully performed during the secondary checkout and the user's payment transaction is successfully settled with the PSP (40).

Preferably, the only checkout that is directly visible to the user (10) is the primary checkout. The secondary checkout performed by the checkout module, that controls all required merchant checkouts, occurs in the background so that it is not as such visible to the user (10).

Although not illustrated in the FIG. 8, according to some embodiments, the checkout module (232) may be configured to control the primary checkout.

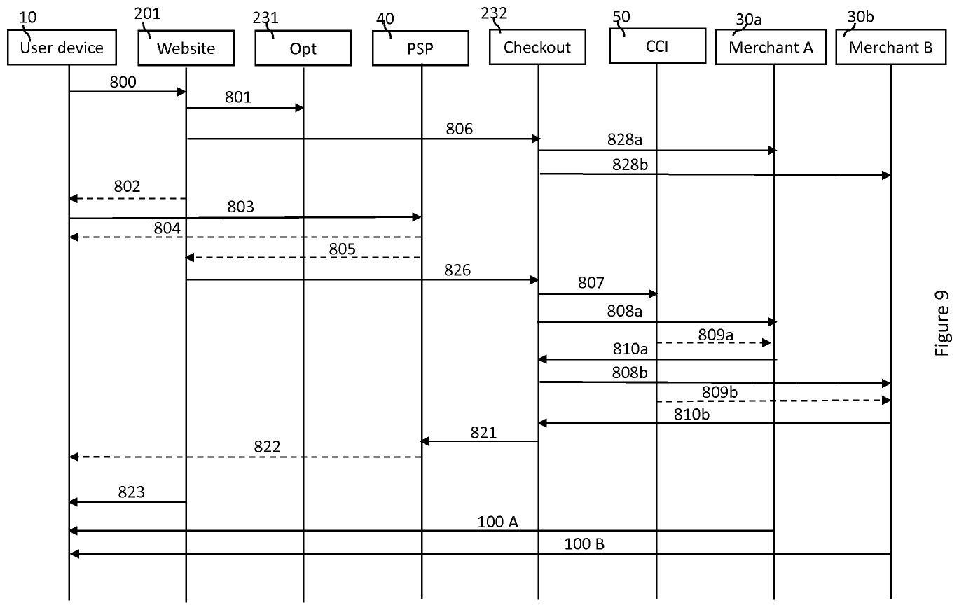

The FIG. 9 illustrates schematically main steps of a method of performing a purchase using the MAS website (201) according to a second embodiment.

In this embodiment, products are placed (828a, 828b) in the selected merchant carts right after optimizing the aggregated shopping cart but before proceeding to the primary checkout and payment by the user (10). Placing the products in each merchant cart in an early phase enables speeding up both the first and secondary checkout processes. Placing the selected products in the respective merchant carts has the further benefit that these products become reserved in the respective merchant system at least for a limited time period, which ensures that the optimized purchase can be performed as planned.

Steps (802, 803, 804, 805) for performing the payment by the user (10) are similar to what has already been disclosed above. Upon receiving (805) a confirmation of preauthorization for the payment from the PSP (40), the secondary checkout process proceeds to initiating the secondary checkout process by the user (10) placing the purchase instruction (806) via the website (201). According to this embodiment, merchant checkouts (808a, 808b) are initiated and performed at respective merchant systems for purchasing the products included in the received purchase instruction (806). If the purchase instruction (806) corresponds to the optimized aggregated shopping cart, all products were already placed in the respective merchant cart(s) in the respective merchant system(s) as illustrated by steps 828a and 808b. Thus, the process can proceed directly to performing merchant checkouts, comprising placing respective merchant purchase orders and performing payments using the at least one virtual credit, debit or credit/debit card issued by the CCI (50) as explained above. Upon receiving confirmations (810a, 810b) of successful merchant checkouts, the checkout module (232) confirms (821) the successful secondary checkout to the PSP (40). The PSP (40) then confirms settling (822) of the user's payment transaction to the user (10).

Although not illustrated in the FIG. 9, according to some embodiments, the checkout module (232) may be configured to control the primary checkout.

It is apparent to a person skilled in the art that as technology advances, the basic idea of the invention can be implemented in various ways. The invention and its embodiments are therefore not restricted to the above examples, but they may vary within the scope of the claims.

1.-14. (canceled)

15. A method performed by a merchandise aggregation service, the method comprising:
communicating with a plurality of third-party merchant systems to obtain contents of a product catalogue of each third-party merchant system, each product catalogue including product details, product prices and product delivery details for a plurality of products;
consolidating obtained product details into product data;
receiving a plurality of product queries from a user device and providing to the user device, in response to each respective product query, product data, product prices and product delivery details for a subset of products matching the product query;
receiving a plurality of add-to-cart instructions from the user device, each add-to-cart instruction comprising identifying one or more selected products;
communicating with one or more of the plurality of third-party merchant systems to obtain availability, price and/or delivery information for each selected product from each of the plurality third-party merchant systems whose product catalogue contains the respective selected product;
determining a combination of third-party merchants from which the selected products can be obtained for the lowest price and/or a combination of third-party merchants from which the selected products can be obtained with the fastest delivery speed;
providing one or more price offers to the user device, the price offers comprising the lowest price and/or the fastest delivery speed for the selected products;
receiving a purchase instruction from the user device, the purchase instruction indicating a selected price offer among the one or more price offers; and
carrying out purchase transactions for the selected products from the third-party merchants comprised in the determined combination of third-party merchants based on the purchase instruction, wherein the purchase transactions are carried out by the merchandise aggregation service on behalf of a user of the user device.

16. The method of claim 15, wherein said consolidating obtained product details comprises:
categorizing products based on product details in the contents of the product catalogue obtained from each third-party merchant system after obtaining the contents of the product catalogue from the respective third-party merchant system,
performing product matching by mutually associating the same products comprised in contents of obtained product catalogues of more than one third-party merchant system, wherein said product matching utilizes said categorizing of the products, and
storing the categorized and matched products as product data in a product database.

17. The method of claim 16, further comprising:
consolidating product details of the matching products in the respective contents of the product catalogues of said third-party merchant systems into said product data.

18. The method of claim 15, wherein obtained contents of the product catalogue of each third-party merchant system comprises one or more offers, the method further comprising:
categorizing a new offer after obtaining contents of the product catalogue from the respective third-party merchant system, wherein the offer comprises product details, product price and product delivery details;
performing offer matching for mutually associating the new offer with an existing product in the product data that are in the same category; and
adding or linking the new offer with product data of the matching existing product, or
if it is determined, in the step of performing offer matching, that there is no existing product in the product data that matches the new offer,
generating new product data based on product details comprised in the categorized new offer, and
adding or linking the new offer with said new product data.

19. The method of claim 15, wherein product data is stored as product records, and wherein each product record comprises product details such as product name, product category or categories, product attributes, product specifications, product reviews, and wherein each product record comprises or is linked to at least one offer comprising third-party merchant information comprising product stock data, delivery time, delivery terms and cost data, and product price of the respective third-party merchant, and wherein offers are provided for each third-party merchant providing the same product.

20. The method of claim 16, wherein the subset of products is selected from the product database.

21. The method of claim 16, wherein the method further comprises obtaining said product data, product prices and product delivery details for the subset of products matching the product query to the user device from the product database.

22. The method of claim 15, wherein the communicating with one or more of the plurality of third-party merchant systems to obtain availability, price and/or delivery information further comprises:
requesting discounted product prices from the third-party merchant systems and obtaining discounted product prices from the third-party merchant systems.

23. The method of claim 15, wherein carrying out the purchase transaction comprises:
obtaining a preauthorization for a payment transaction by the user, wherein total sum of the payment corresponds to combined price of all products included in said purchase instruction; and
obtaining at least one virtual temporary credit, debit or credit/debit card, wherein the debit or credit limit of the at least one virtual temporary credit, debit or credit/debit card equals to said total sum of the payment transaction; and
carrying out a purchase transaction with each third-party merchant comprised in the determined combination of third-party merchants using one of the at least one virtual temporary credit, debit or credit/debit cards,
or
obtaining at least one a virtual temporary credit, debit or credit/debit card, wherein the debit or credit limit of the at least one virtual temporary credit, debit or credit/debit card equals to a portion of said total sum of the payment transaction; and
carrying out a purchase transaction with each third-party merchant comprised in a subset of the determined combination of third-party merchants using one of the at least one the virtual temporary credit, debit or credit/debit cards; and
carrying out a purchase transaction with remaining one or more third-party merchants comprised in the determined combination of third-party merchants but not included in the subset of the determined combination of third-party merchants using an alternative payment transaction method, such as a SEPA payment;
or
carrying out purchase transactions with each of the third-party merchants in the determined combination of third-party merchants using an alternative payment transaction method, such as a SEPA payment; and
confirming settling the purchase transaction to the user device upon completing the purchase transactions with said third-party merchants comprised in the determined combination of third-party merchants.

24. The method of claim 15, the method further comprising, after providing one or more price offers to the user device, adding one or more of the selected products in one or more third-party merchant carts provided by the respective one or more third-party merchant systems based on the provided one or more price offers to the user device.

25. The method of claim 24, wherein the one or more selected products are added in said one or more third-party merchant carts before or after said receiving a purchase instruction from the user device.

26. An apparatus comprising at least one processor, and at least one memory including program code, wherein the at least one memory and the computer program code are configured, with the at least one processor, to cause the apparatus to perform operations comprising:
communicating with a plurality of third-party merchant systems to obtain contents of a product catalogue of each third-party merchant system, each product catalogue including product details, product prices and product delivery details for a plurality of products;
consolidating obtained product details into product data;
receiving a plurality of product queries from a user device and providing to the user device, in response to each respective product query, product data, product prices and product delivery details for a subset of products matching the product query;
receiving a plurality of add-to-cart instructions from the user device, each add-to-cart instruction comprising identifying one or more selected products;
communicating with one or more of the plurality of third-party merchant systems to obtain availability, price and/or delivery information for each selected product from each of the plurality third-party merchant systems whose product catalogue contains the respective selected product;
determining a combination of third-party merchants from which the selected products can be obtained for the lowest price and/or a combination of third-party merchants from which the selected products can be obtained with the fastest delivery speed;
providing one or more price offers to the user device, the price offers comprising the lowest price and/or the fastest delivery speed for the selected products;
receiving a purchase instruction from the user device, the purchase instruction indicating a selected price offer among the one or more price offers; and
carrying out purchase transactions for the selected products from the third-party merchants comprised in the determined combination of third-party merchants based on the purchase instruction, wherein the purchase transactions are carried out by the merchandise aggregation service on behalf of a user of the user device.

27. The apparatus of claim 26, wherein said consolidating obtained product details comprises:
categorizing products based on product details in the contents of the product catalogue obtained from each third-party merchant system after obtaining the contents of the product catalogue from the respective third-party merchant system,
performing product matching by mutually associating the same products comprised in contents of obtained product catalogues of more than one third-party merchant system, wherein said product matching utilizes said categorizing of the products, and
storing the categorized and matched products as product data in a product database.

28. The apparatus of claim 26, wherein obtained contents of the product catalogue of each third-party merchant system comprises one or more offers, to cause the apparatus to perform operations further comprising:
categorizing a new offer after obtaining contents of the product catalogue from the respective third-party merchant system, wherein the offer comprises product details, product price and product delivery details;
performing offer matching for mutually associating the new offer with an existing product in the product data that are in the same category; and
adding or linking the new offer with product data of the matching existing product, or
if it is determined, in the step of performing offer matching, that there is no existing product in the product data that matches the new offer,
generating new product data based on product details comprised in the categorized new offer, and
adding or linking the new offer with said new product data.

29. A computer program product comprising instructions which, when the computer program product is executed by a computer device or system, cause the computer device or system to perform operations comprising the method of claim 15.

30. The computer program product of claim 29, wherein said consolidating obtained product details comprises:
categorizing products based on product details in the contents of the product catalogue obtained from each third-party merchant system after obtaining the contents of the product catalogue from the respective third-party merchant system,
performing product matching by mutually associating the same products comprised in contents of obtained product catalogues of more than one third-party merchant system, wherein said product matching utilizes said categorizing of the products, and
storing the categorized and matched products as product data in a product database.

31. The computer program product of claim 29, wherein obtained contents of the product catalogue of each third-party merchant system comprises one or more offers, to cause the computer device or system to perform operations further comprising:
categorizing a new offer after obtaining contents of the product catalogue from the respective third-party merchant system, wherein the offer comprises product details, product price and product delivery details;
performing offer matching for mutually associating the new offer with an existing product in the product data that are in the same category; and
adding or linking the new offer with product data of the matching existing product, or
if it is determined, in the step of performing offer matching, that there is no existing product in the product data that matches the new offer,
generating new product data based on product details comprised in the categorized new offer, and
adding or linking the new offer with said new product data.

32. A computer-readable medium comprising instructions which, when executed by a computer device or system, cause the computer device or system to perform operations comprising:
communicating with a plurality of third-party merchant systems to obtain contents of a product catalogue of each third-party merchant system, each product catalogue including product details, product prices and product delivery details for a plurality of products;
consolidating obtained product details into product data;
receiving a plurality of product queries from a user device and providing to the user device, in response to each respective product query, product data, product prices and product delivery details for a subset of products matching the product query;
receiving a plurality of add-to-cart instructions from the user device, each add-to-cart instruction comprising identifying one or more selected products;
communicating with one or more of the plurality of third-party merchant systems to obtain availability, price and/or delivery information for each selected product from each of the plurality third-party merchant systems whose product catalogue contains the respective selected product;
determining a combination of third-party merchants from which the selected products can be obtained for the lowest price and/or a combination of third-party merchants from which the selected products can be obtained with the fastest delivery speed;
providing one or more price offers to the user device, the price offers comprising the lowest price and/or the fastest delivery speed for the selected products;
receiving a purchase instruction from the user device, the purchase instruction indicating a selected price offer among the one or more price offers; and
carrying out purchase transactions for the selected products from the third-party merchants comprised in the determined combination of third-party merchants based on the purchase instruction, wherein the purchase transactions are carried out by the merchandise aggregation service on behalf of a user of the user device.

33. The computer-readable medium of claim 32, wherein said consolidating obtained product details comprises:
categorizing products based on product details in the contents of the product catalogue obtained from each third-party merchant system after obtaining the contents of the product catalogue from the respective third-party merchant system,
performing product matching by mutually associating the same products comprised in contents of obtained product catalogues of more than one third-party merchant system, wherein said product matching utilizes said categorizing of the products, and
storing the categorized and matched products as product data in a product database.

34. The computer-readable medium of claim 32, wherein obtained contents of the product catalogue of each third-party merchant system comprises one or more offers, to cause the computer device or system to perform operations further comprising:
categorizing a new offer after obtaining contents of the product catalogue from the respective third-party merchant system, wherein the offer comprises product details, product price and product delivery details;
performing offer matching for mutually associating the new offer with an existing product in the product data that are in the same category; and
adding or linking the new offer with product data of the matching existing product, or
if it is determined, in the step of performing offer matching, that there is no existing product in the product data that matches the new offer,
generating new product data based on product details comprised in the categorized new offer, and
adding or linking the new offer with said new product data.
